(19) United States
(12) Patent Application Publication
(10) Pub. No.: US 2012/0288168 A1
(43) Pub. Date: Nov. 15, 2012

(54) SYSTEM AND A METHOD FOR ENHANCING APPEAREANCE OF A FACE

(75) Inventors: Arvind Channarayapatna SRINIVASA, Bangalore (IN); Ravi Bangalore RAMARAO, Bangalore (IN); Sridhar NAGARAJ, Bangalore (IN); Suresh NARASIMHA, Bangalore (IN)

(73) Assignee: TELIBRAHMA CONVERGENT COMMUNICATIONS PVT. LTD., Bangalore (IN)

(21) Appl. No.: 13/466,154

(22) Filed: May 8, 2012

(30) Foreign Application Priority Data
May 9, 2011 (IN) 1596/CHE/2011

(51) Int. Cl. G06K 9/34

(52) U.S. Cl. 382/118

(57) ABSTRACT

The embodiments herein provide a system and a method for enhancing the appearance of the image of a user by analyzing the facial characteristics of an image of a user in real time. The system includes an image capturing device for capturing an image of a user and transmitting the captured image to the image processing unit for analyzing the facial characteristics of the image. The image processing unit includes a segmentation module and a marking module for marking the anomalies in the facial characteristics of the captured image to estimate an age of a skin in the captured image of the user. The image processing unit performs a segmentation of the face region of the image to extract the facial features to detect the skin anomalies and removes the skin anomalies to provide an enhanced image based on an estimated age of the user.

### CROSS-REFERENCE TO RELATED APPLICATION

The embodiments herein claims the priority of the Indian Provisional Patent Application No. 1596/CHE/2011 filed on 9 May 2011 having the title “System and Method for Enhancing Appearance of a Face of an object”, and the contents of which are incorporated by reference herein.

### BACKGROUND

1. Technical field

The embodiments herein generally relate to the image processing systems and methods and particularly relate to enhance the surface characteristics of a face from an image in real time. The embodiments herein more particularly relate to a system and a method for capturing and processing an image of a user for enhancing the appearance of a user in real time.

2. Description of the Related Art

Conventionally there exist various photography enhancement techniques for improving the appearance of a person within a photographed image. For example, the techniques for removing the blemishes, wrinkles and other anomalies from a photographed face have existed for many years. However, such image enhancing techniques requires a trained/skilled photographer to analyze and enhance the quality of the captured image.

With the introduction of digital image processing techniques, the users can capture a digital image of an object and efficiently view and manipulate features of the captured image according to their interest. Such digital processing techniques generally demands image enhancement software to select certain image features from a chosen image for digital enhancement.

Even though such digital image processing techniques have produced more efficient and user friendly image enhancement operation, it requires a finite amount of cost in employing the image processing techniques. Also the user needs to spend a considerable amount of time and effort in selecting and modifying the image features. Moreover such image processing methods do not perform any statistical analysis of the skin features to determine the anomalies associated with the skin. Furthermore, there are no methods available for a user to view their skin quality in order to provide them an additional insight into the condition of their skin to allow them to take a well informed decision regarding the purchase of the skin care products or treatment.

Hence there is a need to provide a system and a method for performing an automated image enhancement to enhance an appearance of a user in real time. There also exists a need for a system and a method for analyzing the surface statistics from the image of a user in real time to enhance the appearance.

The abovementioned shortcomings, disadvantages and problems are addressed herein and which will be understood by reading and studying the following specification.

### OBJECTS OF THE EMBODIMENTS

The primary object of the embodiments herein is to provide an appearance enhancement system and a method to automatically analyze the facial statistics from an image of a user.

Another object of the embodiments herein is to provide an appearance enhancement system and a method to enhance the appearance of the facial features in real time.

Another object of the embodiments herein is to provide an appearance enhancement system and a method with an image capturing option to capture the image of the user in real time.

Yet another object of the embodiments herein is to provide an appearance enhancement system and a method to generate a detailed report on the facial characteristics based on the analysis of the facial statistics of the user.

Yet another object of the embodiments herein is to provide an appearance enhancement system and a method that does not require any reference image for appearance enhancement.

Yet another object of the embodiments herein is to provide an appearance enhancement system and a method that assesses the age of the user and quality of the skin of the user.

Yet another object of the embodiments herein is to provide an appearance enhancement system and a method to digitally remove the wrinkles, blemishes, age spots, dark circles and improves a color tone to enhance the appearance of the user.

Yet another object of the embodiments herein is to provide an appearance enhancement system and a method to suggest the dermatological products to the user based on the assessment of the skin characteristics retrieved from the image.

Yet another object of the embodiments herein is to provide an appearance enhancement system and a method to suggest the cosmetic treatments to the user based on the assessment of the skin characteristics derived from the image.

Yet another object of the embodiments herein is to provide an appearance enhancement system and a method which requires only less time to estimate the facial features of the user.

Yet another object of the embodiments herein is to provide an appearance enhancement system and a method which requires only minimal or no user interaction.

Yet another object of the embodiments herein is to provide an appearance enhancement system and a method which can efficiently apply the cosmetic effects to the captured image to improve the appearance of the user.

These and other objects and advantages of the embodiments herein will become readily apparent from the following detailed description taken in conjunction with the accompanying drawings.

### SUMMARY

The embodiments herein provide a system for enhancing the appearance of a user by analyzing the facial characteristics from an image of a user. The system includes an image capturing device, a digital screen, and an image processing unit. The image capturing device captures an image of a user and transmits the captured image to the image processing unit for analyzing the facial characteristics of the image. The image processing unit comprises a segmentation module and a marking module for marking the anomalies in the facial characteristics of the captured image to estimate an age of a skin in the image captured of the user by displaying in the digital screen.

The digital screen transmits the captured image of the user to the image processing unit. The digital screen herein is a virtual mirror and the image capturing device is a 2-dimensional camera/video recorder. The image processing unit analyzes the facial characteristics of the user by segmenting the face region to get the facial features from the image. The image processing unit further detects the marks, the wrinkles, the age spots, the acne marks, the dark circles, the moles and other anomalies associated with the skin from the extracted image. The image processing unit further estimates the skin age using the wrinkles and age spots marked and transmits the image of the user with the wrinkles and age spots marked along with the estimated age to the digital screen. The system further displays the image of the user with the wrinkles and age spots marked on the image along with the estimated age of the user. Simultaneously, the image processing unit removes the wrinkles, the age spots, the acne marks, the dark circles and the other anomalies associated with the skin and displays the cleaned up image of the user along with the marked image on the digital screen.

The embodiments herein provide a method for enhancing the appearance of a user by analyzing the facial characteristics from an image of a user in real-time. The method includes capturing the image of the user standing in front of a digital screen, transmitting the captured image of the user to an image processing unit for a facial analysis. The method also includes extracting a face and the facial features from the image and detecting the wrinkles, age spots, acne marks and moles from the extracted image. The method further includes marking the wrinkles, age or blemish spots, moles and acne marks on the facial region of the user based on the analysis of the input image. The method includes estimating the skin age using the wrinkles and the age spots marked in the input image. The method also includes transmitting and displaying the image of the user with the wrinkles and the age spots marked and also with the estimated age of the user in the digital screen.

According to an embodiment herein, the digital screen is an electronic device. The electronic device includes but is not limited to a touch screen device, a PDA, and a mobile device.

According to an embodiment herein, the digital screen includes a display unit for displaying the image of the user with the wrinkles and the age spots marked on the image and a cleaned up image of the user along with the estimated ages.

According to an embodiment herein, the image processing unit employs a modified windowing method with a new mask to perform an appearance enhancement process.

According to an embodiment herein, the image processing unit performs a plurality of analysis on the captured image to produce a plurality of data representing skin features of the user face. The plurality of analysis include an evaluation of a skin color, an evaluation of the pigmented spots, an evaluation of the dark circles, an evaluation of the wrinkles and/or an evaluation of the age spots.

According to an embodiment herein, the image processing unit removes the false detections from the captured image for an accurate marking and a removal of the skin anomalies.

According to an embodiment herein, the image processing unit estimates the skin age based on the extent of the wrinkles and the age spots marked on the facial image.

According to an embodiment herein, the method further includes removing the wrinkles, the aging spots or the blemish spots, and the acne marks from the image of the user and displaying the cleaned up image to the user.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of an appearance enhancement system, according to an embodiment herein.

FIG. 2 illustrates a flow chart explaining a method for enhancing the appearance of a user through an image analysis, according to an embodiment herein.

FIG. 3 illustrates a flow chart explaining a method for marking the wrinkles on the input image of a user, according to an embodiment herein.

FIG. 4 illustrates a flow chart explaining a method for marking the moles and acne marks on the input image of a user, according to an embodiment herein.

FIG. 5 illustrates a flow chart explaining a method for marking the age spots on the input image of a user, according to an embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide an appearance enhancement system for analyzing the facial characteristics from an image of a user to enhance the appearance of the user. The system includes a digital screen, an image capturing device and an image processing unit. The image capturing device captures the image of a user standing in front of the digital screen. The digital screen transmits the captured image of the user to the image processing unit. The digital screen herein is a virtual mirror and the image capturing device is a 2-dimensional camera/video recorder. The image processing unit analyzes the facial characteristics of the user by segmenting the face region using Active Shape Model (ASM) to get the facial features from the image. The image processing unit further detects the marks, wrinkles, age spots, acne marks, dark circles, moles and other anomalies associated with the skin from the extracted image using the sobel and gabor filters. The image processing unit further estimates the skin age using the wrinkles and the age spots with the help of a skin age estimation statistical tree marks and transmits the image of the user with the wrinkles and age spots marked along with the estimated age to the digital screen. The system further displays the image of the user with the wrinkles and age spots marked on the image along with the estimated age of the user. Simultaneously, the image processing unit removes the wrinkles, the age spots, the acne marks, the dark circles and other anomalies associated with the skin with the help of Weighted Least Square (WLS) and Inpaint methods and displays the cleaned up image of the user along with the marked image on the digital screen.

The digital screen herein is an electronic device. The electronic device includes but is not limited to a touch screen device, a PDA, and a mobile device. The digital screen includes a display unit for displaying the image of the user with the wrinkles and the age spots marked on the image and a cleaned up image of the user along with the estimated ages.

The image processing unit employs a modified windowing method with a new mask to perform an appearance enhancement process. The image processing unit performs a plurality of analysis on the captured image to produce a plurality of data representing the skin features of the user face. The plurality of analysis include an evaluation of a skin color, an evaluation of the pigmented spots, an evaluation of the dark circles, an evaluation of the wrinkles and/or an evaluation of the age spots. The image processing unit further removes the false detections from the captured image for an accurate marking and a removal of the skin anomalies and estimates the skin age based on the extent of the wrinkles and the age spots marked on the facial image

The embodiments herein further provide a method for enhancing the appearance of a user by analyzing the facial characteristics from an image of the user in real-time. The method includes capturing an image of a user standing in front of the digital screen, transmitting the captured image of the user to an image processing unit for a facial analysis. The method also includes extracting a face and the facial features from the image using Active Shape Model (ASM) and detecting the wrinkles, the age spots, the acne marks and the moles from the extracted image using the sobel and gabor filters. The method further includes marking the wrinkles, the aging spots or the blemish spots, the moles and the acne marks on the facial region of the user based on the analysis done using the sobel and gabor filters on the input image. The method includes estimating the skin age using the wrinkles and the age spots with the help of a skin age estimation statistical tree and marks them on the input image. The method also includes transmitting and displaying the image of the user with the wrinkles and the age spots marked and also with the estimated age of the user in the digital screen.

The method further includes removing the wrinkles, the aging spots or the blemish spots and the acne marks from the image of the user with the help of Weighted Least Square (WLS) and Inpaint methods and displays the cleaned up image to the user.

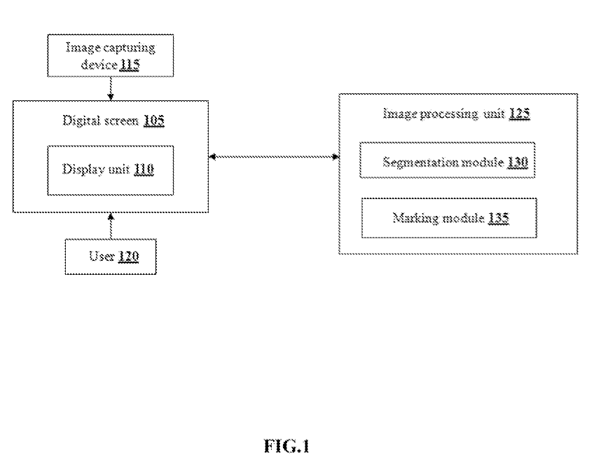

FIG. 1 illustrates a block diagram of an appearance enhancement system, according to an embodiment herein. With respect to FIG.1, the appearance enhancement system includes a digital screen 105, an image capturing device 115 and an image processing unit 125.The image capturing device 115 is mounted on the digital screen 105. A user 120 stands in front of the digital screen 105 and the image capturing device 115 captures the image of the user 120.Further the captured image is transmitted to the image processing unit 125. The image processing unit 125 herein is one of a software module, hardware module or a combination thereof. The digital screen 105 herein is a virtual mirror and the image capturing device 115 is a 2-dimensional camera/video recorder.

The digital screen 105 includes a display unit 110 for displaying the captured image of the user 120. The image processing unit 125 detects any portion of the image that defines the face of the user 120. The image processing unit 125 analyzes the facial characteristics of the user by segmenting the face region to extract the facial features from the image. On identifying the face, the image processing unit 125 further analyzes the facial characteristics of the user 120 from the image and extracts the facial features to be enhanced. The image processing unit 125 includes a segmentation module. 130 for segmenting the face region from the input image to detect the wrinkles, the age spots, and the moles. The segmentation module 1.30 segments the face region from the captured image to detect the anomalies in the facial characteristics of the image captured of the user 120. The image processing unit 125 also includes a marking module 135 for marking the wrinkles, the age spots or the blemish spots, the moles and the acne marks on the input image The anomalies include but are not limited to the wrinkles, the blemish spots, the moles and the acne marks.

The image processing unit 125 estimates the skin age using the wrinkles and the age spots marked and transmits the image of the user 120 with the wrinkles and the age spots marked to the digital screen 105 along with the estimated age of the user 120 based on the image. The marked up image and the estimated age is then displayed on the display unit 110 of the digital screen 105. Also the image processing unit 125 removes the wrinkles and the age spots marked on the image of the user 120 and display an image with an enhanced appearance along with the corresponding estimated age.

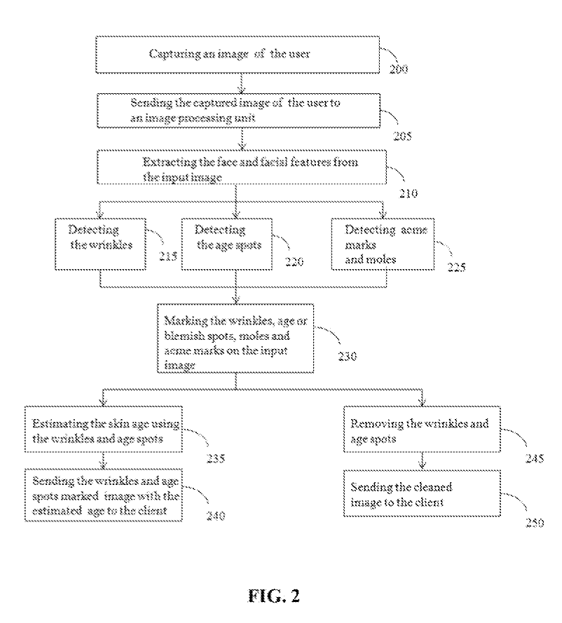

FIG. 2 illustrates a flow chart explaining a method for enhancing the appearance of a user through an image analysis according to an embodiment herein. The method for analyzing the facial characteristics of an image includes initiating an appearance enhancement system, capturing the image of a user standing in front of the image capturing device, transmitting the captured image of the user to an image processing unit, extracting a face region from the captured image, detecting at least one of the wrinkles, the age spots, the acne marks and the moles from the face region extracted, marking the face region with at least one of wrinkles, the blemish spots, the moles and the acne marks detected, analyzing the facial characteristics of the image captured through an estimation of the skin age based on the wrinkles, the age spots, the moles and the acne marks marked in the captured image, displaying the image with the wrinkles, the age spots, the moles and the acne marks marked to the user.

The image of the user standing in front of the digital screen is captured by an image capturing device with a face detection technique in a controlled environment (200). The captured image of the user is transmitted to an image processing unit for a facial feature analysis (205). The segmentation module segments the face region from the captured image to detect the anomalies in the facial characteristics of the captured image of the user.

The face and facial features from the image are extracted (210) and the facial regions having wrinkles are detected from the image input to the image processing system (215). The facial regions having age spots are detected from the image input to the image processing system (220). The facial regions having acne marks and moles are detected from the image input to the image processing system (225). The facial regions with wrinkles, the age, spots or the blemish spots, the moles, and the acne marks are marked on the input image (230). The image processing unit further use the image processing techniques for estimating the skin age based on the wrinkles and the age spots marked in the input image (235).

The image processor transmits the image of the user back to the digital screen and the digital screen displays it through a display unit provided in the digital screen (240). The display unit displays the wrinkles and the age spots marked along with a report including the estimated age of the user based on the input image.

The image processing unit simultaneously performs the image processing techniques to remove the wrinkles, the age spots and the acne marks detected in the captured image of the user (245). Further the image processing unit displays the clean image of the user on the display unit of the digital screen (250). The system further generates a detailed report on the facial characteristics based on the analysis of the facial statistics of the user.

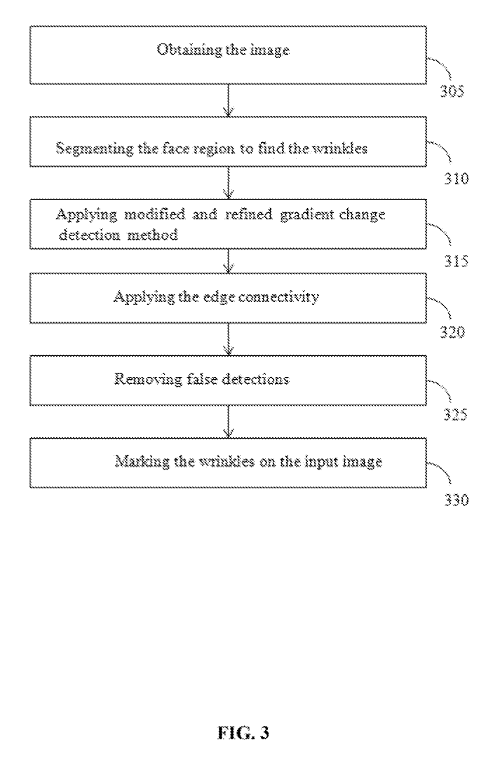

FIG. 3 illustrates a flow chart explaining a method for marking the wrinkles on the input image of a user, according to an embodiment herein. With respect to FIG.3, the image of the user captured by the image capturing device associated with a digital screen is sent to the image processing unit. The image processing unit receives the image of the user transmitted from the digital screen (305). The image processing unit performs a segmentation of the facial region to detect the parts having wrinkles (310). During the segmentation process, the face region of the image is cropped. The image processing units applies a modified and refined gradient change detection technique on the segmented face region (315). The image processing units further apply an edge connectivity technology (320) and removes false detection of the wrinkles from the facial region (325). The image processing unit further marks the wrinkles accurately on the input image (330).

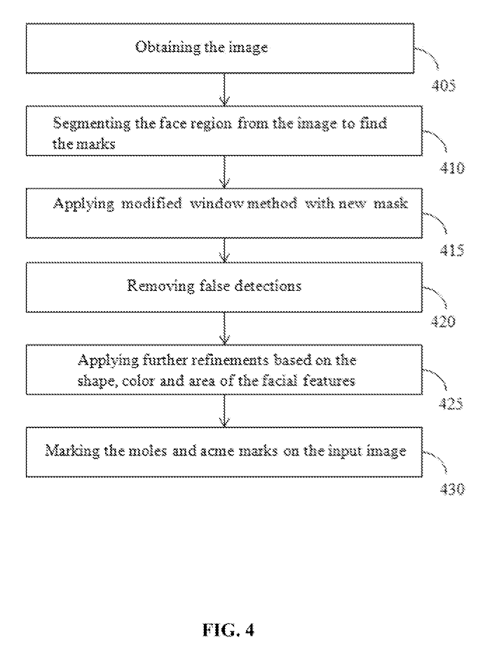

FIG. 4 illustrates a flow chart explaining a method for marking the moles and acne marks on the input image using an appearance enhancement system, according to an embodiment herein. With respect to FIG.4, the captured image of the user is sent to the image processing unit for analyzing the facial characteristics. The image processing unit receives the image of the user transmitted from the digital screen (405). The image processing unit performs a segmentation of the facial region to detect the parts having the wrinkles (410). During a segmentation process, the face region of the image is cropped. The image processing unit applies a modified window technique with the new mask on the segmented face region (415). The image processing unit further removes the false detections from the input image (420). The image processing unit further performs refinements based on the shape, color and area of the image (425). The image processing unit further marks the moles and the acne marks accurately on the input image (430).

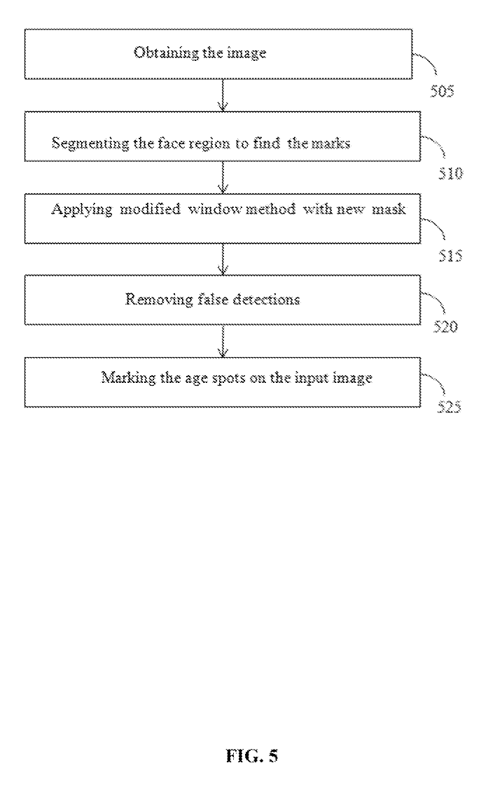

FIG. 5 illustrates a flow chart explaining a method for marking the age spots on the input image captured using an appearance enhancement system, according to an embodiment herein. With respect to FIG.5, the image is captured by the camera in real time. The captured image of the user is sent to the image processing unit for analyzing the facial characteristics. The image processing unit receives the image of the user transmitted from the digital screen (505). The image processing unit performs a segmentation of the facial region to find the marks (510). The image processing unit applies a modified window method with the new mask on the segmented face region (515). The image processing unit further removes the false detections (520) from the input image and marks the moles and the acne marks accurately on the input image (525). The appearance enhancement methodology, when performed on the image of a user, is adapted to reduce the wrinkle effect, increase the skin color of the face, detect the age spots and removing the spots, analyze the details about the beard and removing the beard, showing the face after removing spectacles, estimating the quality of the skin and the like.

The image processing unit extracts the facial features by Active shape model (ASM) for marking the age spots on the input image. During a segmentation, the face region of the image is cropped and further applies Laplacian of Gaussian (LOG) operator on the grey scale image. The image processing unit then detects the contour region inside the facial features of the image and removes the gradient contents by filling the region from neighborhood information. The image processing unit further employs the image smoothing techniques over the input image to even out the surface characteristics.

Though the embodiments herein are described in a reference to enhance the facial characteristics of a user, the embodiments herein are also applicable to any field where there is an estimation and a enhancement of surface characteristics of the face is involved.

The embodiments herein provide an appearance enhancement system that captures an image or records the video of the user in real time to enhance an appearance of a person in the image. The image capturing device used in the present invention is a 2-dimensional camera which is comparatively less expensive to the conventional 3D data scan devices. The appearance enhancement system herein provides a marked up image and a clean image of the user thereby enabling the user to visually identify the skin problems. Since the image enhancement is automatic, it requires a relatively minimal or no effort to enable a user to produce the pleasing images. The estimation of a skin age enables the user to select the appropriate cosmetic products/treatment to correct the skin problems. The appearance enhancement system performs a real time image capturing and analysis and does not require any reference images for improving the appearance of the image of the user.

The foregoing description of the specific embodiments herein will so fully reveal the general nature of the embodiments herein that others can, by applying current knowledge, readily modify and/or adapt for various applications such specific embodiments herein without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of the preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments herein with modifications. However, all such modifications are deemed to be within the scope of the claims. It is also to be understood that the following claims are intended to cover all the generic and specific features of the embodiments described herein and all the statements of the scope of the embodiments which as a matter of language might be said to fall there between.

What is claimed is:

1. An appearance enhancement system comprising:
a digital screen;
an image capturing device attached to the digital screen to capture an image of a user; and
an image processing unit to process the captured image for analyzing a facial characteristics of the user;
wherein the image processing unit is adapted to detect and mark a skin anomalies, estimate a skin age, remove the skin anomalies and display an enhanced image of the user on the digital screen.

2. The system of claim 1, wherein the digital screen comprises a display unit for displaying the image with the marked anomalies in the facial characteristics and the estimated age of the skin in the captured image of the user.

3. The system of claim 1, wherein the image processing unit comprises:
a segmentation module to segment a face region from the captured image to detect the anomalies in the facial characteristics of the user; and
a marking module for marking the anomalies in the facial characteristics of the captured image to estimate an age of a skin from the captured image of the user.

4. The system of claim 3, wherein the marking module marks the anomalies in the facial characteristics of the captured image automatically using a modified window method.

5. The system of claim 1, wherein the image processing unit enhances the captured image of the user by removing the marked wrinkles, age spots and acne marks based on an estimated age of the skin of the user.

6. The system of claim 1, wherein the digital screen is a virtual mirror.

7. The system of claim 1, wherein the image capturing device is a two-dimensional camera or a video recorder.

8. A method for enhancing an appearance of a user, the method comprises:
capturing an image of a user;
transmitting the captured image of the user to an image processing unit;
segmenting a face region from the captured image;
detecting a one or more skin anomalies on the extracted face region;
marking the one or more skin anomalies detected on the face region;
analyzing the facial characteristics of the captured image;
displaying the image of the user with the marked skin anomalies;
removing the skin anomalies in the facial characteristics of the marked image in the captured image of the user; and
displaying an enhanced image of the user with removed skin anomalies in the facial characteristics.

9. The method of claim 8, further comprises displaying an enhanced image with a corresponding estimated age of the user.

10. The method of claim 8, wherein the one or more skin anomalies include wrinkles, age spots, acne marks, dark circles, moles and any other anomalies associated with the skin.

11. The method of claim 8, wherein the extracting the face region of the user comprises:
segmenting the face region from the captured image; and
cropping the segmented face region;
wherein the face region is segmented by applying a refined gradient change detection method on the segmented face region.

12. The method of claim 8, wherein analyzing the facial characteristics from an image comprises:
estimating the skin age based on wrinkles, age spots moles and acne marks marked in the captured image; and
identifying a plurality of false detections from the captured image for accurately marking and removing the skin anomalies.

13. The method of claim 8, wherein the skin anomalies are removed from the captured image by applying an edge connectivity technique.
